(19) United States
(12) Patent Application Publication
(10) Pub. No.: US 2014/0137042 A1
(43) Pub. Date: May 15, 2014

(54) MENU DISPLAY METHOD AND SYSTEM, RADIAL MENU, AND STORAGE MEDIUM

(71) Applicant: TENCENT TECHNOLOGY (SHENZHEN) COMPANY LIMITED, SHENZHEN (CN)

(72) Inventors: Jian Du, SHENZHEN (CN); GE GAO, SHENZHEN (CN)

(73) Assignee: TENCENT TECHNOLOGY (SHENZHEN) COMPANY LIMITED, SHENZHEN (CN)

(21) Appl. No.: 14/162,217

(22) Filed: Jan. 23, 2014

Related U.S. Application Data
(63) Continuation of application No. PCT/CN2012/076980, filed on Jun. 15, 2012.

(30) Foreign Application Priority Data
Aug. 4, 2011 (CN) CN 201110222739.3

(51) Int. Cl. G06F 3/0482; G06F 3/0488; G06F 3/0481

(52) U.S. Cl. CPC G06F 3/0482; G06F 3/04817; G06F 3/0488
USPC 715/834

(57) ABSTRACT

A menu implementing method, comprising: establishing a mapping set between a sub-area and an operation; obtaining an operation event at a starting point being located at the edge of a screen, and popping-up a fan-shaped menu at the edge of the screen according to the operation event; obtaining a distance and an angle between a user's operation point and the starting point; searching a corresponding operation in the mapping set according to the obtained distance and angle; performing the found operation. This menu implementing method enables triggering a menu at the edge of the screen and improves the expansibility of the menu in the same direction. Furthermore, a menu implementing system, a fan-shaped menu and storage medium are provided.

### CROSS-REFERENCES TO RELATED APPLICATIONS

This application is a continuation of International Application No. PCT/CN2012/076980, filed on Jun. 15, 2012, which claims priority to Chinese patent application No. 201110222739.3, filed on Aug. 4, 2011, the contents of which are incorporated herein by reference in their entirety.

### FIELD OF THE DISCLOSURE

The present disclosure relates to human-machine interactive interface, and in particular relates to a menu implementing method, system, a fan-shaped menu and a storage medium.

### BACKGROUND

In a human-machine interactive interface, different interface elements would trigger different menus. In a traditional human-machine interactive interface, a context menu is generally implemented where upon clicking one specific interface element (e.g. a button), the context menu is displayed with various function items, and clicks on which cause corresponding operations to be performed. However, there are a limited number of function items that the traditional context menu is capable of displaying, particularly when it is applied to a hand-held apparatus with a small display screen, the display of the context menu is apparently limited.

Traditionally, a circle menu scheme has also been employed, which by clicking the touch screen, displays the function items of a menu on a circle having a preset distance as the radius and the touching point as the center of the circle. However, in this case, when the click on the touch screen locates at the edge of the screen, not all the menu function items on the circle can be displayed on the screen, and such a radial menu has no expansibility in the same direction. Therefore, a traditional menu is limited.

### SUMMARY

In view of the above, there is a need to provide a menu implementing method, which can enable triggering a menu at an edge of screen and improve expansibility in the same direction.

A menu implementing method is provided, comprising the steps of:

establishing a mapping set between a sub-area and an operation;

obtaining an operation event at a starting point being located at the edge of a screen, and popping-up a fan-shaped menu at the edge of the screen according to the operation event;

obtaining a distance and an angle between a user's operation point and the starting point;

searching a corresponding operation in the mapping set according to the obtained distance and angle;

performing the found operation.

Furthermore, there is a need to provide a menu implementing system, which enables triggering a menu at an edge of screen and improve expansibility in the same direction.

A menu implementing system is provided, comprising:

a setting module, configured to establish a mapping set between a sub-area and an operation;

a displaying module, configured to obtain an operation event at a starting point being located at an edge of a screen, and pop up a fan-shaped menu at the edge of the screen according to the operation event;

a processing module, configured to obtain a distance and an angle between a user's operation point and the starting point;

a searching module, configured to search a corresponding operation in the mapping set according to the obtained distance and angle;

an executing module, configured to perform the found operation.

Furthermore, a fan-shaped menu is provided.

A fan-shaped menu, wherein the fan-shaped menu pops up upon obtaining an operation event at a starting point being located at the edge of a screen;

The fan-shaped menu comprises a plurality of sub-areas being divided according to a distance and an angle between the fan-shaped menu and the starting point, each of the plurality of sub-areas comprising an item representing a menu function item of a corresponding operation.

Furthermore, a storage medium comprising computer executable instructions is provided.

a storage medium comprising computer executable instructions, the computer executable instructions being used to perform a menu implementing method, wherein the method comprises the steps of:

establishing a mapping set between a sub-area and an operation;

obtaining an operation event at a starting point being located at the edge of a screen, and popping-up a fan-shaped menu at the edge of the screen according to the operation event;

obtaining a distance and an angle between a user's operation point and the starting point;

searching a corresponding operation in the mapping set according to the obtained distance and angle;

performing the found operation.

The above-mentioned method, system, fan-shaped menu and storage medium, by means of establishing a mapping set between a sub-area and an operation, obtains an operation event at a starting point being located at an edge of a screen and pops-up a fan-shaped menu at the edge of the screen; obtains a distance and an angle between a user's operation point and the starting point when the user is operating on the fan-shaped menu; searches a corresponding operation in the mapping set and execute the found operation. As the starting point locates at the edge of the screen, triggering a menu at the edge of the screen is enabled, thus operating the menu with one hand only is applicable; and a corresponding operation according to the distance and the angle between the operation point and the starting point is searched, such that since the fan-shaped menu can be expanded in terms of the distance and the angle, thus the expansibility in the same direction is improved.

### BRIEF DESCRIPTION OF THE DRAWINGS

FIG. 1 is a flowchart diagram illustrating a menu implementing method according to an embodiment of the present disclosure;

FIG. 2 is a schematic diagram of the setting of a fan-shaped area according to an embodiment of the present disclosure;

FIG. 3 is a schematic diagram of the interface of a fan-shaped menu according to an embodiment of the present disclosure;

FIG. 4 is a schematic diagram of the interface of a fan-shaped menu according to another embodiment of the present disclosure;

FIG. 5 is a configuration schematic diagram of a menu implementing system according to an embodiment of the present disclosure.

### DETAILED DESCRIPTION

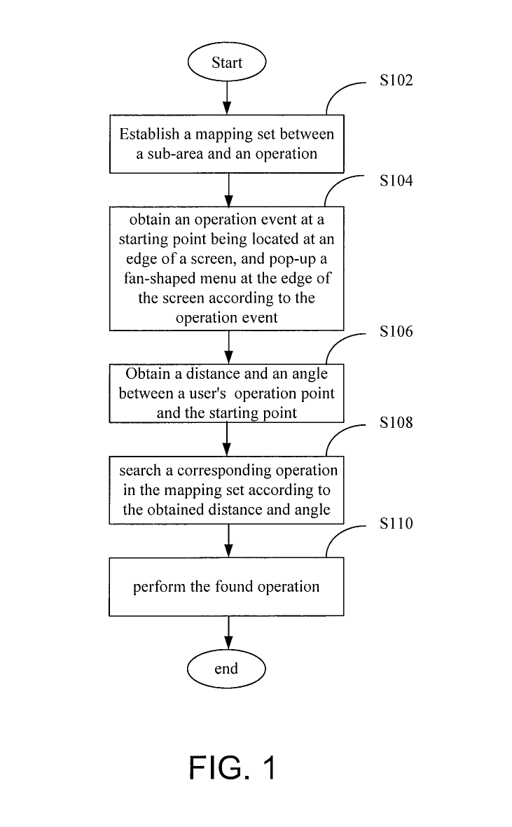

As shown in FIG. 1, in an embodiment of the present disclosure, a menu implementation method comprises the following steps.

At step S102, a mapping set between a sub-area and an operation is established.

In an embodiment, prior to step S102, a fan-shaped area or a circular section at an edge of a screen is set with a starting point at an edge of a screen being the center of a circle, and the fan-shaped area is divided into a plurality of sub-areas or sub-sections according to a distance and angle between the fan-shaped area and the starting point.

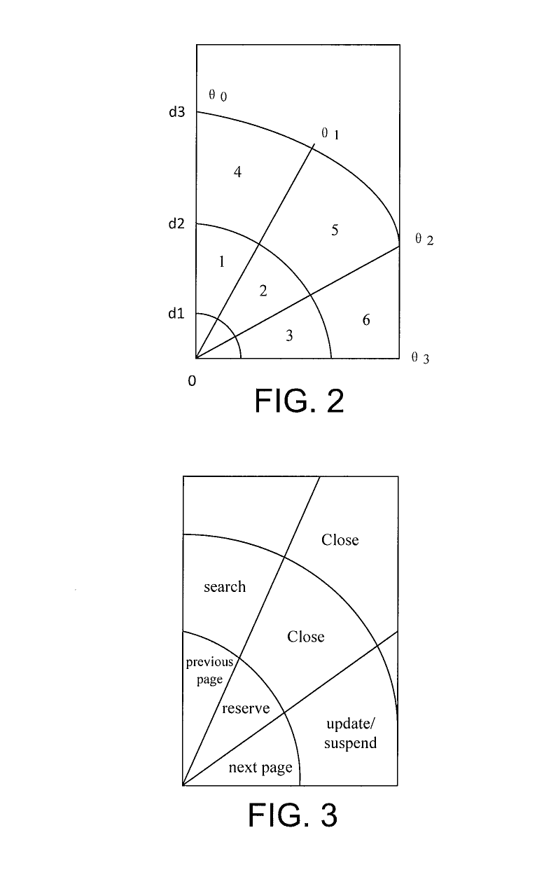

As shown in FIG. 2, the fan-shaped area is divided along the radius thereof in the unit of preset distance, and it is further divided in the unit of preset angle, into a plurality of sub-areas, which are shown as sub-areas 1-6 in FIG. 2.

Since the fan-shaped area is divided according to the distance and angle, the mapping set between the sub-areas and the operations records the mapping relationship between the range of distance and angle and the operations. In an embodiment, corresponding to the fan-shaped area shown in FIG. 2, a mapping set established in this manner is illustrated in Table 1.

TABLE 1

| | an- | θ > θ0&&θ ≦ | θ > θ1&&θ ≦ | θ > θ2&&θ ≦ |
|---|---|---|---|---|
| | gle | θ1 | θ2 | θ3 |
| distance | — | — | — | — |
| d > d1&&d ≦ d2 | — | Operation1 | Operation2 | Operation3 |
| d > d2&&d ≦ d3 | — | Operation4 | Operation5 | Operation6 |

Wherein operations 1-6 correspond to the operations to be implemented by the menu function items on sub-areas 1-6.

At step S104, an operation event at the starting point located at the edge of a screen is obtained, and a fan-shaped menu at the edge of the screen pops up according to the operation event.

In this embodiment, the screen is a touch screen. As shown in FIG. 2, a button is displayed at the starting point, and in this case, the button is set to be displayed at the lower left corner of the screen. The operation event on that button is obtained, and the operation event can be a click operation (click or double-click) or a long-press operation. In an embodiment, it is determined whether an operation on the button is a long-press operation, if yes, then a fan-shaped menu pops up at the edge of the screen; otherwise, this operation of the user is ignored.

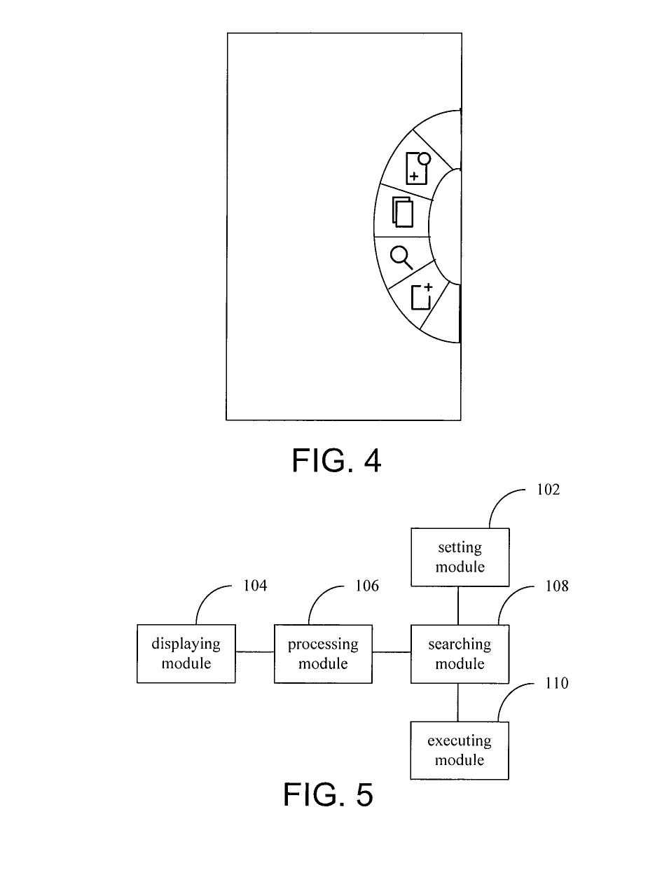

As shown in FIG. 3, when the starting point is located at one of the four corners at an edge of the screen, a fan-shaped menu pops up with the starting point being the centre of a circle. As shown in FIG. 4, when the starting point is located in the middle of an edge of the screen, the popped-up fan-shaped menu with the starting point being the center of a circle may be of semi-circle shape. After the fan-shaped menu pops up, corresponding menu function items are displayed in each of the set sub-areas. The menu function items can be either presented in texts (as shown in FIG. 3), or with specific icons (as shown in FIG. 4).

At step S106, the distance and the angle between the operation point of the user and the starting point is obtained.

In this embodiment, after the fan-shaped menu pops up, the user operates on that menu e.g. clicks a function item in the menu. Then the operation point of the user is obtained, and the distance and the angle between the operation point and the starting point is calculated in real-time.

In an embodiment, a polar coordinate of the user's operation point is obtained, and the distance and the angle between the operation point and the starting point is obtained according to the polar coordinate. As shown in FIG. 2, taking the starting point as the pole, the vertical axis as the polar axis, a polar system is built up, then the polar coordinate of the user's operation point is obtained and represented as (ρ,θ), wherein ρ denotes the straight-line distance between the operation point and the starting point, θ denotes the angle between the line connecting the operation point and the starting point and the polar axis. The distance and the angle between the operation point and the starting point can be obtained directly without conversion through the obtaining of the polar coordinate of the operation point, so the calculation amount can be reduced.

At step S108, a corresponding operation is searched in the mapping set according to the obtained distance and angle.

In this embodiment, the detailed process at step S108 is that, a sub-area in which the operation point locates is derived from the obtained distance and angle, and then an operation corresponding to that sub-area is searched in the mapping set. In an embodiment, it is determined before S108 whether an operation on the menu is completed, e.g. by determining whether a release event is detected, if a release event is detected—indicating an operation of the user on the menu is completed, then the process moves to step S108; otherwise it returns to step S106 to obtain in real-time the distance and angle between the operation point and the starting point.

In an embodiment, at step S108, it is determined whether a sub-area having been set can be found, if yes, which indicates that the user has operated on a function item in the fan-shaped menu, then an operation corresponding to that sub-area is searched in the mapping set and the process moves to step S110; if no, which indicates that the user has operated on an area outside of the fan-shaped menu other than a function item in the fan-shaped menu, then that fan-shaped menu is hidden.

At step S110, the found operation is performed.

In this embodiment, once a corresponding operation is found in the mapping set, that operation is performed directly. As shown in FIG. 3, an operation can be page turning, closing the current window, searching, updating/suspending etc; as shown in FIG. 4, an operation can also be zoom-in display, adding to favorites etc.

As shown in FIG. 5, in an embodiment, a menu implementing system comprises a setting module 102, a displaying module 104, a processing module 106, a searching module 108 and an executing module 110, wherein:

The setting module 102 is used for establishing a mapping set between a sub-area and an operation.

In an embodiment, the setting module 102 is also used for setting a fan-shaped area at an edge of the screen with the starting point being the center of a circle, and for dividing the fan-shaped area into a plurality of sub-areas according to a distance and an angle between the fan-shaped area and the starting point.

As shown in FIG. 2, the setting module 102 divides the fan-shaped area along the radius thereof in the unit of preset distance, and further divides it in the unit of preset angle, thus divides the fan-shaped area into a plurality of sub-areas, which are shown as sub-areas 1-6 in FIG. 2.

Since the fan-shaped area is divided according to the distance and angle, the mapping set between the sub-areas and the operations records the mapping relationship between the range of distance and angle and the operations. In an embodiment, corresponding to the fan-shaped area shown in FIG. 2, a mapping set established in this manner is illustrated in Table 1.

The displaying module 104 is used for obtaining an operation event at the starting point located at the edge of a screen, and popping-up a fan-shaped menu at the edge of the screen according to the operation event.

In an embodiment, the displaying module 104 is also used for displaying a button at the starting point, obtaining the operation event on the button, popping-up a fan-shaped menu according to the operation event, and then displaying corresponding menu function items in the sub-areas.

As shown in FIGS. 3 and 4, based on the location of the starting point, the fan-shaped menu can be of fan shape or semi-circle shape. The menu function items can be either presented in texts, or with specific icons. In this embodiment, the displaying module 104 is used for obtaining a click or a long-press operation on the button, and when it is determined that the operation on the button is one of the click and long-press operations, a fan-shaped menu pops up at the edge of the screen; otherwise the operation of the user is ignored.

In an embodiment, the processing module 106 is used for obtaining the distance and the angle between the operation point of the user and the starting point.

In an embodiment, the processing module 106 is used for obtaining the polar coordinate of the user's operation point, and obtaining the distance and the angle between the operation point and the starting point according to the polar coordinate. As shown in FIG. 2, taking the starting point as the pole, the vertical axis as the polar axis, a polar system is built up, then the polar coordinate of the user's operation point is obtained and represented as (ρ,θ), where ρ denotes the straight-line distance between the operation point and the starting point, θ denotes the angle between the line connecting the operation point and the starting point and the polar axis. The distance and the angle between the operation point and the starting point can be obtained directly without conversion through the obtaining of the polar coordinate of the operation point, so the calculation amount can be reduced.

The searching module 108 is used for searching a corresponding operation in the mapping set according to the obtained distance and angle.

In an embodiment, the searching module 108 is used for obtaining a sub-area in which the operation point locates from the obtained distance and angle, and searching an operation corresponding to that sub-area in the mapping set. In an embodiment, the searching module 108 is also used for determining whether a set sub-area can be found, if yes, which indicates that the user has operated on a function item in the fan-shaped menu, then an operation corresponding to that sub-area is searched in the mapping set and the executing module 110 is informed; if no, which indicates that the user has operated on an area outside of the fan-shaped menu other than a function item in the fan-shaped menu, then the displaying module 104 hides that fan-shaped menu.

The execution module 110 is used for performing the found operations.

Once a corresponding operation is found in the mapping set, that operation is performed directly. As shown in FIG. 3, an operation can be page turning, closing the current window, searching, updating/suspending etc; as shown in FIG. 4, an operation can also be zoom-in display, adding to favorites etc.

The above-mentioned menu implementing method and system, by means of obtaining an operation event at the starting point being located at the edge of screen, pops up a fan-shaped menu at the edge of the screen, thus can trigger a menu at the edge of the screen intuitively, and this helps a user to implement complicated operations with one hand and is particularly applicable for situation where the user operates with his thumb. The above-mentioned menu implementing method and system divides a fan-shaped menu into a plurality of sub-areas according to distances and angles, wherein in each sub-area a different menu function item is displayed, thus expansibility of the menu in the same direction is improved because the fan-shaped menu can to expand in the same direction according to a distance and an angle. By searching a corresponding operation according to a distance and an angle, the calculation amount can be reduced. Consequently, compared to the traditional menu, the above-mentioned menu implementing method and system can improve convenience of the user's operation, is applicable to a variety of hand-held apparatus that use a touch screen, so can meet user's experience demand.

The fan-shaped area shown in FIG. 2 and the fan-shaped menus in FIGS. 3 and 4 are only exemplary embodiments for illustrating the above-mentioned menu implementing method and system, and should not be used to limit the menu implementing method and system as mentioned above. In general a fan-shaped menu is any circular sector shaped menu. The form and interface layout of a fan-shaped menu may vary depending on its location, the screen size and any specific application.

It will be understood by a person skilled in the art that all or parts of the procedure in the above-mentioned implementation method can be accomplished by computer executable instructions to instruct related hardware, and the computer executable instructions can be stored in a computable readable storage medium, and when the computer executable instructions are executed, these may include the procedures of the various above-mentioned methods. Among others, the storage medium may be a magnetic disk, an optical disk, ROM (Read-Only Memory) or RAM (Random Access Memory) etc.

The above description has only illustrated a few embodiments of the present disclosure, although have been described in considerable details, they should not be construed as the limitation of the scope of the present disclosure. It will be obvious that those skilled in the art can make modifications and variations to the above embodiments without departing the spirit and scope of the present disclosure. Therefore, the scope of the present disclosure should be determined by the appended claims.

What is claimed is:

1. A method of displaying a menu at a screen of a hand-held apparatus, the method, comprising:
in response to receiving a first event corresponding to a user touching the screen, displaying a circular sector shaped menu wherein a point along a perimeter of the circular sector shaped menu is aligned with a first edge of the screen;
in response to the user touching the screen at a location within the displayed circular sector shaped menu, receiving a distance and an angle corresponding to the location;
searching for a corresponding operation from a plurality of operations based on distance and angle; and
performing the found operation.

2. The method according to claim 1, wherein displaying the circular sector shaped menu comprises:
circular sector shaped menu into a plurality of sub-areas and associating each of the plurality of sub-areas with a respective each of the plurality of operations.

3. The method according to claim 2 further comprises:
displaying a corresponding menu function items in each of the plurality of the sub-areas.

4. The method according to claim 1, wherein obtaining a distance and an angle comprises:
obtaining a polar coordinate of the location, and obtaining the distance and the angle between location and the point according to the polar coordinate.

5. The method according to claim 2, wherein searching a corresponding operation based on the obtained distance and angle comprises:
determining a sub-area of the screen in which the location is located according to the obtained distance and angle, and selecting the one of the plurality of operations corresponding to the determined sub-area.

6. The method according to claim 2, wherein dividing the circular sector shaped menu into a plurality of sub-areas comprises:
dividing the circular sector shaped menu along the radius thereof in the unit of preset distance, and further dividing the circular sector shaped menu in the unit of preset angle, such that dividing the fan-shaped area into a plurality of sub-areas.

7. A menu implementing apparatus, comprising:
one or more processors;
memory; and
one or more modules stored in the memory and to be executed by the one or more processors, the one or more modules including:
a setting module, configured to establish a mapping set between a sub-area and an operation;
a displaying module, configured to obtain an operation event at a starting point being located at an edge of a screen, and pop up a fan-shaped menu at the edge of the screen according to the operation event;
a processing module, configured to obtain a distance and an angle between a user's operation point and the starting point;
a searching module, configured to search an corresponding operation in the mapping set according to the obtained distance and angle; and
an executing module, configured to perform the found operation.

8. The menu implementing apparatus according to claim 7, wherein the setting module is further configured to set a fan-shaped area at the edge of the screen with the starting point being a center of a circle, and to divide the fan-shaped area into a plurality of sub-areas according to a distance and an angle between the fan-shaped area and the starting point.

9. The menu implementing apparatus according to claim 8, wherein the displaying module is further configured to display a button at the starting point, obtain an operation event on the button, pop up a fan-shaped menu at the fan-shaped area according to the operation event, and display corresponding menu function items in the sub-areas.

10. The menu implementing apparatus according to claim 7, wherein the processing module is further configured to obtain a polar coordinate of the user's operation point, and obtain the distance and the angle between the operation point and the starting point according to the polar coordinate.

11. The menu implementing apparatus according to claim 7, wherein the searching module is further configured to obtain a sub-area in which the operation point is located according to the obtained distance and angle, and search an operation corresponding to the sub-area in the mapping set.

12. A fan-shaped menu displayed at a touch-sensitive display screen, wherein the fan-shaped menu is displayed upon obtaining an operation event at a starting point being located along an edge of the touch-sensitive display screen;
the fan-shaped menu comprises a plurality of sub-areas being divided according to a distance and an angle between a fan-shaped menu and the starting point, each of the plurality of sub-areas comprising an item representing a menu function item of a corresponding operation.

13. The fan-shaped menu according to claim 12, wherein the fan-shaped menu is displayed upon obtaining an operation on a button displayed at the location of the starting point.

14. The fan-shaped menu according to claim 12, wherein the distances and angles between the fan-shaped menu and the starting point are represented as polar coordinates.

15. The fan-shaped menu according to claim 12, wherein texts and icons representing corresponding menu function items are displayed in various sub-areas.

16. The method of claim 1 wherein the circular sector shaped menu corresponds to a semicircle and wherein aligning the point along the perimeter comprising locating a diametrical edge of the semicircle with the first edge of the screen.

17. The method of claim 1 wherein the circular sector shaped menu corresponds to a quadrant with a first linear edge and a second linear edge and wherein aligning a point along the perimeter of the quadrant comprising locating the first linear edge of the quadrant with the first edge of the screen and locating the second linear edge with the second edge of the screen.
